(19) United States
(12) Patent Application Publication
(10) Pub. No.: US 2020/0036880 A1
(43) Pub. Date: Jan. 30, 2020

(54) DETECTING FLUID ON A SURFACE

(71) Applicant: Microsoft Technology Licensing, LLC, Redmond, WA (US)

(72) Inventors: Sergio ORTIZ EGEA, San Jose, CA (US); Michael Scott FENTON, Sunnyvale, CA (US); Venkata Satya Raghavendra BULUSU, Fremont, CA (US); Riaz Imdad ALI, Fremont, CA (US)

(73) Assignee: Microsoft Technology Licensing, LLC, Redmond, WA (US)

(21) Appl. No.: 16/045,592

(22) Filed: Jul. 25, 2018

(51) Int. Cl. H04N 5/235; H04N 5/374; G06T 7/514; G06T 7/529; G06T 7/11

(52) U.S. Cl. CPC H04N 5/2352; H04N 5/374; G06T 7/514; G06T 2207/20081; G06T 7/11; G06T 2207/10152; G06T 7/529

(57) ABSTRACT

Examples are disclosed that relate to methods and systems for determining if a fluid is present on a surface. In one example, a method comprises illuminating the surface with narrow-band light and using an image sensor comprising a narrow-bandpass filter matching the bandwidth of the narrow-band light to obtain a first image of the surface. A second image of the surface with the narrow-band light deactivated is obtained. A third image is generated by subtracting the second image from the first image. The third image is thresholded, one or more contrasting regions are detected, and the presence of fluid on the surface is determined.

### BACKGROUND

Fluid spills may pose challenges and create hazards in a variety of areas, including commercial spaces such as grocery stores and other retail establishments. Detecting fluid spills quickly can protect public safety. However, fluid spills can be difficult to identify in images, as ambient light conditions may not provide sufficient contrast to detect transparent fluids or small spills on a surface.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to methods and systems for determining if a fluid is present on a surface. In one example, a method comprises illuminating the surface with narrow-band light and using a differential complementary metal-oxide-semiconductor (CMOS) image sensor to obtain an image of the surface. The image is thresholded and one or more contrasting regions are detected in the image. The method then determines, based on detecting the one or more contrasting regions in the image, that the fluid is present on the surface.

In another example, a method comprises illuminating the surface using narrow-band light. An image sensor comprising a narrow-bandpass filter matching a bandwidth of the narrow-band light is used to obtain a first image of the surface illuminated using the narrow-band light. The narrow-band light is deactivated and the image sensor is used to obtain a second image of the surface while the narrow-band light is deactivated. A third image is generated by subtracting the second image from the first image. The third image is then thresholded and one or more contrasting regions are detected in the third image. The method then determines, based on detecting the one or more contrasting regions in the third image, that the fluid is present on the surface.

### BRIEF DESCRIPTION OF THE DRAWINGS

FIG. 1 shows a block diagram illustrating an example system for determining if a fluid is present on a surface according to examples of the present disclosure.

FIG. 2 is an illustrative example of a use case scenario in which an image capture device and an illumination device are used to determine if a fluid is present on a surface.

FIG. 3 is a flow chart of an example method for determining if a fluid is present on a surface using a differential complementary metal-oxide-semiconductor image sensor according to examples of the present disclosure.

FIG. 4 is a flow chart of another example method for determining if a fluid is present on a surface according to examples of the present disclosure.

FIG. 5 shows a block diagram of a computing system according to examples of the present disclosure.

FIG. 6 shows a simplified diagram of a differential complementary metal-oxide semiconductor image sensor.

FIG. 7 illustrates a simplified schematic diagram and a timing diagram of a differential complementary metal-oxide semiconductor image sensor.

### DETAILED DESCRIPTION

Fluid spills may pose challenges and create hazardous conditions in a variety of areas, such as grocery stores and other retail spaces. For example, a grocery store may have aisles full of fluids in containers that may leak or spill their contents onto a floor and cause customers to slip. Fluid spills are common hazards in many other places, including shopping malls, restaurants, research laboratories, etc. In places like these, quick detection and cleanup of fluid spills may protect public safety.

In some examples, cameras may be deployed to monitor surfaces, such as a floor, for signs of a fluid spill. For example, images from security cameras, which may already be deployed in environments such as a store, may be analyzed to detect fluid spills. However, security cameras often have high field of view optics, with low resolution and poor quantum efficiency that makes it difficult to obtain enough contrast to detect a fluid on a surface.

In other examples, a fluid may be detected by analyzing the fluid's spectral signature. The spectral signature may include wavelengths that enable the detection of the fluid via absorption, fluorescence, or reflectance of the wavelength(s). Similar techniques may be used in remote sensing applications to identify fluids in aerial or satellite imagery. However, the different spectral signatures of different fluids can complicate generic spectral signature detection techniques. Further, different substances in a fluid may change its spectral signature. For example, turbidity caused by particles, chemical or biological components may change a fluid's spectral signature enough that the fluid may not be detected.

In addition, surface tension may cause a fluid to rapidly spread into a thin layer having very smooth surfaces and rounded edges. This may reduce contrast between the surface and the fluid, thereby making contrast detection more difficult. Further, some common fluids spilled in public spaces, such as water, bleach, and ammonia, are transparent to visible light, making it even more difficult to detect the fluid.

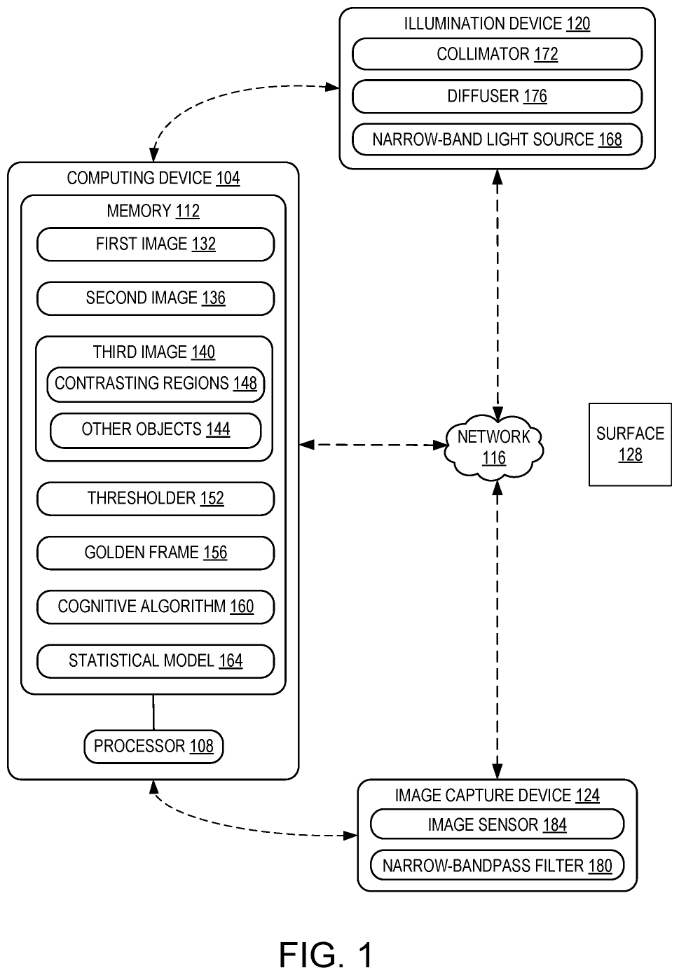

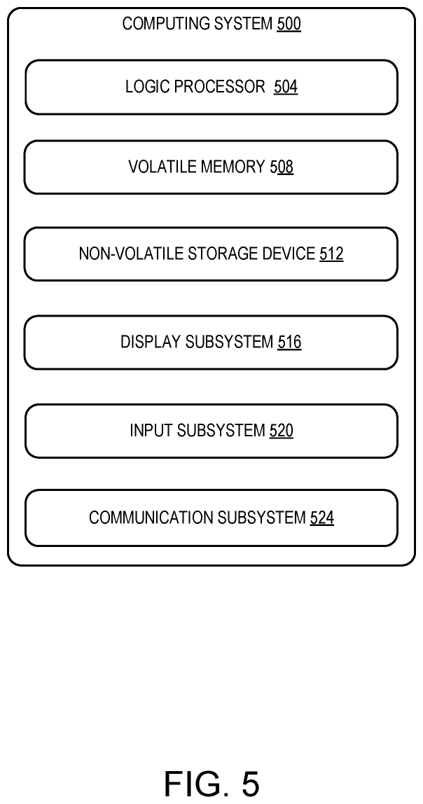

Accordingly, examples are disclosed that relate to methods and systems for determining if a fluid is present on a surface. With reference now to FIG. 1, in one example, a computing device 104 may comprise a processor 108 and a memory 112 holding instructions executable by the processor 108 to determine if fluid is present on a surface as described herein. In some examples, the computing device 104 may comprise a network server, edge computing device, internet-of-things (IoT) device, a desktop, laptop or tablet computer, mobile computing device, mobile communication device (e.g., smart phone), and/or other computing device that may or may not be physically integrated with other components described herein. Additional details regarding the components and computing aspects of the computing device 104 are described in more detail below with reference to FIG. 5.

In some examples, the computing device 104 may be communicatively coupled via network 116 with one or more illumination device(s) 120 and/or one or more image capture device(s) 124, with each of the image capture device(s) 124 comprising an image sensor 184. As described below, in some examples the computing device 104 may be located remotely from the illumination device(s) 120 and image capture device(s) 124, and may host a remote service that determines if fluid is present on a surface as described herein. In other examples, the computing device 104 may be located on the same premises as the image capture device 124 and/or the illumination device 120. In yet other examples, aspects of the computing device 104 may be integrated into one or more of the illumination device 120 and the image capture device 124. In different examples, various combinations of an illumination device 120, an image capture device 124, and aspects of computing device 104 may be enclosed in a common housing.

In some examples, the computing device 104 may activate or control the illumination device 120 to illuminate a surface 128 with narrow-band light. As described in more detail below, and in one potential advantage of the present disclosure, the narrow-band light may comprise one or more of collimated, diffused, or directional narrow-band light that may increase contrast in a fluid present on a surface.

In some examples, as described in more detail below, the computing device 104 may obtain, from the image capture device 124, a first image 132 of the surface illuminated by the illumination device 120. The computing device 104 may control the illumination device 120 to deactivate the illumination device 120, and the computing device 104 may obtain a second image 136 of the surface 128 while the illumination device 120 is deactivated. The computing device 104 may then subtract the second image 136 from the first image 132 to generate a third image 140. As described in more detail below, based on detecting one or more contrasting regions in the third image, the computing device may determine that fluid is present on the surface.

In some examples and as described in more detail below, an image capture device 124 may comprise an image sensor 184 in the form of a differential complementary metal-oxide-semiconductor (CMOS) image sensor. Advantageously, the differential CMOS image sensor may allow the image capture device 124 to capture the first image 132 and the second image 136 during one period of a utility power cycle, which may operate at frequencies such as 50 Hz or 60 Hz. In this manner, ambient light powered at the utility frequency may not flicker during the capture period, and thus the ambient light levels may be substantially equal in both the first image 132 and the second image 136. Accordingly, and in one potential advantage of the present disclosure, the second image 136 may be subtracted from the first image 132 to substantially eliminate the ambient light and leave only light emitted by the illumination device(s) 120. In this manner and as described in more detail below, contrast may be increased to enable more robust detections of fluid present on a surface.

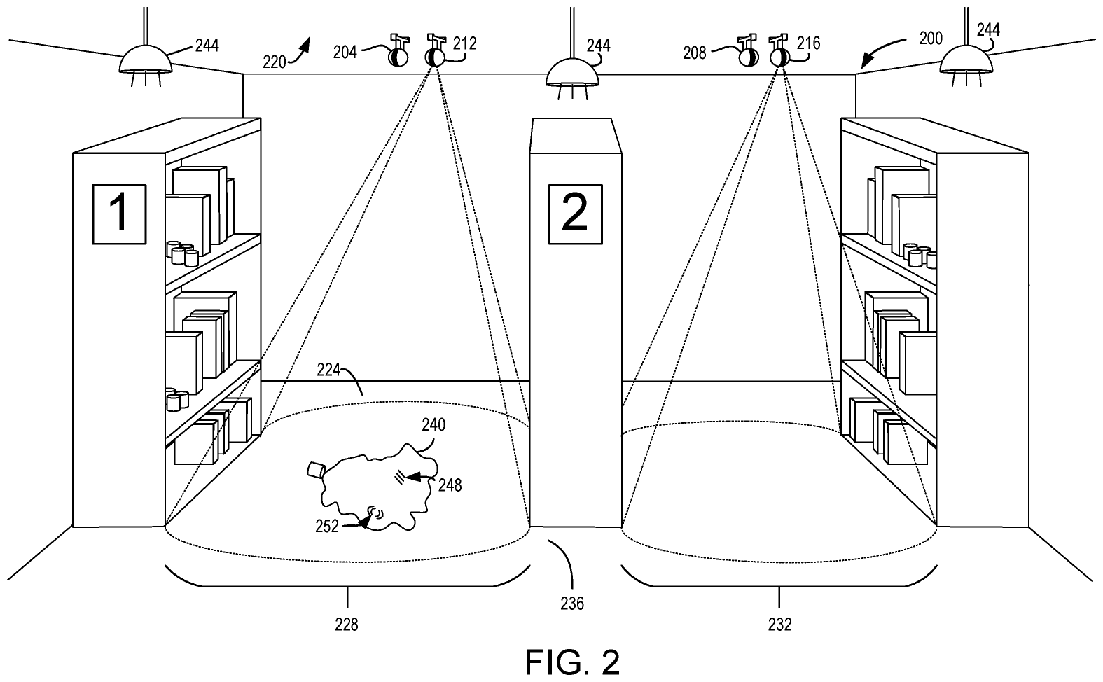

In one example, and with reference now to FIG. 2, a room 200 in a retail store may implement image capture devices 124 in the form of ceiling-mounted image capture devices 204 and 208, and illumination devices 120 in the form of ceiling-mounted illumination devices 212 and 216 to detect a fluid 240 that may be spilled on the floor 224 of the room 200. In the example illustrated in FIG. 2, the image capture device 204 and the illumination device 212 are positioned on the ceiling 220 of the room 200, approximately 4 meters above the floor 224 of a first aisle 228 in the room 200. In some examples, the image capture device 204 and the illumination device 212 may be positioned 10-20 mm apart from each other.

The image capture device 204 and the illumination device 212 may be configured to face the floor 224 to determine if a fluid spill is present on the floor. Likewise, the image capture device 208 and the illumination device 216 may be configured to determine if a fluid spill is present in a second aisle 232 in the room 200. It will be appreciated that one or more image capture devices and illumination devices may be configured in any other suitable manner to obtain an image of a single area, or to obtain images of different areas, such as the first aisle 228 and second aisle 232, which may or may not overlap.

In the example of FIG. 2, the illumination device 212 may be configured to illuminate the floor 224 of the first aisle 228 with narrow-band light 236. The narrow-band light 236 may comprise one or more of collimated, diffused, or directional narrow-band light emitted by the illumination device 212. With reference again to FIG. 1, the illumination device 120 may comprise a narrow-band light source 168, such as a short-coherence LED or a laser. For example, the narrow-band light source 168 may emit light having a bandwidth, such as a full width at half maximum (FWHM), of 25 nm about a central wavelength. It will be appreciated that in other examples, a variety of other bandwidths and central wavelengths may be utilized.

For example, a suitable central wavelength may be chosen based on properties of a fluid to be detected or based on a quantum efficiency of the image sensor 184 of the image capture device 124 with respect to that wavelength of light. For example, the central wavelength emitted by the narrow-band light source 168 may be 470 nm, within a blue region of visible light, which may be suitable for water and similar fluids. In other examples, the central wavelength may be 850 nm, or near infrared, which is absorbed by water. As near-infrared light may not be visible, in these examples the narrow-band light may be made more powerful without disrupting people who may otherwise see it.

Light emitted from the narrow-band light source 168 may be collimated using a collimator 172, such as a collimating lens. In other examples, a diffuser 176 may be used to spread the light to illuminate an area. In one example, the diffuser 176 may have a field of illumination of 80 degrees, within which it may flood an area, such as the floor 224 in the example of FIG. 2, with light, to detect the fluid 240 spilled on the floor 224. In other examples, collimating lenses providing different fields of illumination may be utilized for different use cases.

As described above, ambient lighting may make the fluid 240 difficult to detect. For example, in FIG. 2, ambient light generated by multiple sources, such as a plurality of ceiling-mounted lights 244, may reach the fluid 240 from multiple different angles and directions. Accordingly, the fluid 240 may diffract the ambient light through similarly broad ranges of angles and directions, blurring edges of the fluid 240.

In contrast, and as described above, the narrow-band light 236 emitted by the illumination device 212 may be highly directional. For example, in FIG. 2, the narrow-band light 236 is illustrated as a coherent cone of light illuminating the floor 224. When illuminated by the narrow-band light 236, a flat surface of the fluid 240 may produce one or more highly specular reflections. In some examples, a position of the image capture device 204 with respect to the illumination device 212 may be such that a high contrast region 248, such as a specular reflection, is visible on the surface of the fluid 240. In some examples, ripples 252 on the surface of the fluid 240 may also produce specular reflections. Such specular reflections may notably increase back-scattering of the narrow-band light 236, which may enhance detectability of the fluid 240.

In some examples, surface tension may cause the edges of the fluid 240 to be rounded. In some examples, diffraction at the rounded edges of the fluid 240 may produce a cylindrical scattering wave that may contrast the edges of the fluid from the floor 224. While these edges may be blurred by ambient light, diffraction of the highly-directional narrow-band light 236 may result in more contrast than diffraction of ambient light, either alone or in combination with the narrow-band light. Accordingly, and in one potential advantage of the present disclosure, subtracting a contribution of the ambient light to an image of the fluid 240 illuminated using the narrow-band light 236 may enhance contrast between the floor 224 and the fluid 240. In this manner and as described in more detail below, the systems and methods of the present disclosure may detect one or more contrasting regions in the form of contrasting edges in an image.

In some examples, the ambient light may have a much greater intensity than the narrow-band light 236. This may be especially true in brightly-lit environments, such as the room 200 illustrated in FIG. 2. With reference again to FIG. 1, to subtract the contribution of the ambient light, the first image 132 of the surface 128 may be obtained when the surface is illuminated with both ambient light and with the narrow-band light from illumination device 120. The illumination device 120 may then be deactivated, and the second image 136 of the surface 128 may be obtained while the surface is illuminated with only ambient light. In this manner, the ambient light may be removed from the first image 132 by subtracting the second image 136 from the first image to enhance contrast and detectability of the fluid 240.

A variety of different types of image sensors 184 may be used to capture the first image 132 and/or the second image 136. Examples of image sensors 184 that may be utilized include a charge-coupled device (CCD) image sensor, an InGaAs image sensor, and a CMOS image sensor.

In some examples of systems utilizing one of these example image sensors, images may be captured and processed at a frame rate of 60, 90 or 100 frames per second, which may be on a similar order of magnitude as a utility power frequency with which ambient light sources are powered. For example, the lights 244 in the example of FIG. 2 may flicker on and off at a frequency of 50 Hz or 60 Hz. As such, the ambient light may change in intensity over the time during which an image is captured, thereby contributing noise to the image, reducing the signal-to-noise ratio of the desired signal, and obscuring any contrast between the fluid and the surface.

Accordingly and in these examples, one or more post-processing operations may be used to equilibrate the first image 132 and the second image 136. As one example, landmarks may be selected in the first image 132 and compared to corresponding landmarks in the second image 136 to equalize histograms of these images. In this manner, the baselines of the two images may be equilibrated to allow the ambient light to be more accurately removed from the first image 132 as described above.

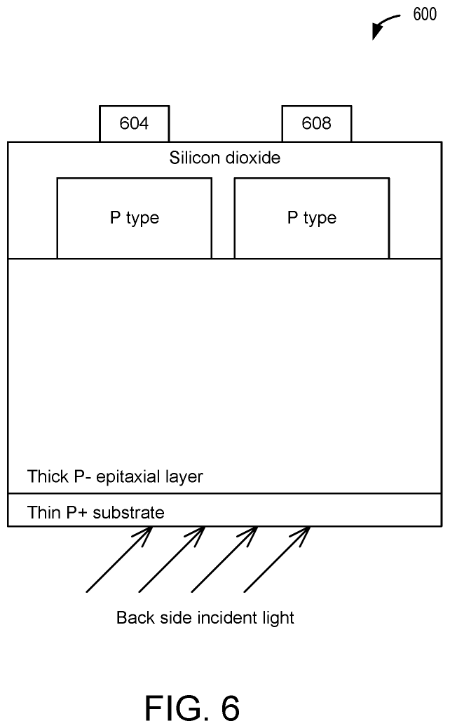

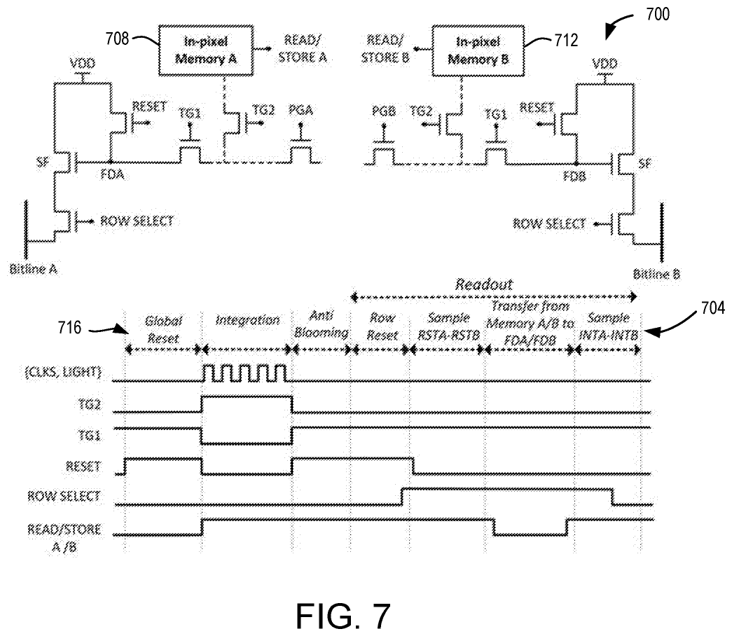

In other examples, such post-processing of captured images may be avoided by utilizing a differential CMOS image sensor to obtain images of the surface. As described in more detail below, differential CMOS sensors may operate with much faster integration times, such as between several microseconds to 1 millisecond, as compared to standard CMOS and other image sensors. In this manner, a differential CMOS image sensor may have a higher maximum frame rate than a standard CMOS image sensor or other common image sensors, and may thereby capture images with higher signal-to-noise ratios. Additional descriptions of an example differential CMOS sensor are provided below with reference to FIGS. 6 and 7.

In one example, and with reference again to FIG. 1, a differential CMOS image sensor 184 may be charged in a first clock cycle by collecting light while the illumination device 120 illuminates the surface 128. In this first clock cycle a first gate is opened to read the first image 132 of the surface 128 that is illuminated by both the narrow-band light 168 and ambient light. In a second clock cycle, the illumination device 120 is deactivated to leave only ambient light illuminating the surface 128. In this second clock cycle, the second image 136 of the surface 128 is read with the second gate while the illumination device 120 is deactivated. The differential CMOS image sensor may then subtract the second image 136 from the first image 132 to generate the third image 140.

Advantageously, the differential CMOS sensor may capture and integrate an image quickly enough such that its operation is invariant to any differences or changes in luminance of the ambient light. In one example, a differential CMOS sensor may integrate an image frame in as little as 3.7 microseconds, or up to 270 frames per second. In this manner, both the first image 132 and the second image 136 may have a similar ambient light baseline for subtraction.

With reference again to FIG. 2, in another potential advantage of using a differential CMOS sensor, the narrow-band light 236 may illuminate the floor 224 for a short time, such as 100 microseconds to 1 millisecond. In this manner, the narrow-band light 236 may have a high intensity while also being illuminated for a short duration that does not disrupt a visual experience of one or more people that may be nearby.

In some examples using either a differential CMOS sensor or another type of image sensor 184, and to further increase a signal-to-noise ratio of captured images, ambient light may be filtered out prior to reaching the image sensor 184. With reference again to FIG. 1, the image capture device 124 may comprise a narrow-bandpass filter 180 matching a bandwidth of the narrow-band light. For example, the narrow-bandpass filter 180 may have a tolerance of 25 nm that corresponds to the FWHM of the narrow-band light source 168. In other examples, a filter with a broader bandwidth, such as 35 nm, that similarly matches the FWHM of the narrow-band light source 168 may be used. As the image sensor 184 may introduce noise into an image in proportion to an overall amount of light collected by the image sensor, filtering light prior to reaching the image sensor 184 may increase the signal-to-noise ratio of the image.

Once the third image 140 has been generated as described above, contrasting algorithms may be implemented to find one or more contrasting regions 148 in the third image 140 that may correspond to a fluid spill. For example, and with reference again to FIG. 1, the computing device 104 may process the third image 140 using a thresholder 152 that may segment and/or enhance contrast in the third image 140. The thresholder 152 may implement a variety of suitable methods for this purpose, such as an edge-locating algorithm based on first order derivatives and/or statistical thresholding, such as a clustering-based image thresholding technique based on Otsu's method.

In some examples, a reference or golden frame 156 representing the surface without the fluid present also may be utilized to identify contrasting regions 148 attributable to a fluid spill. In these examples, the golden frame 156 is compared to an image of interest, such as by subtracting the golden frame 156 from the image of interest. In some examples, the golden frame 156 may be generated in the same manner as described above by subtracting a second image captured with illumination only by ambient light from a first image captured with illumination from both the illumination device 212 and the ambient light.

In the example of FIG. 2, a golden frame 156 of the floor 224 in aisle 228 may be captured by image capture device 204 in early morning, when the room 200 is clean and no fluids are present on the floor. The golden frame 156 may be refreshed periodically when no fluid spills are present, and later used to enhance contrast or determine if a fluid spill is present in the third image 140.

A variety of suitable methods may be used to determine that the fluid spill is present in the third image. In one example, a statistical model 164 may be generated representing the third image 140. The statistical model 164 may comprise a histogram with a plurality of bins to which pixels in the third image 140 may be assigned. When the fluid spill is present, contrasting regions 148 of the fluid spill may change a distribution of pixels in the histogram, enabling the fluid spill to be detected.

In another example, a cognitive algorithm 160, such as a deep neural network, may be trained to detect contrasting regions 148 that may be attributable to the fluid spill. The cognitive algorithm 160 may additionally or alternatively be trained to segment the third image 140, separate a region of interest, such as the surface 128, from other objects 144 in the third image 140, or perform any other applicable function.

In some examples, the cognitive algorithm 160 and the statistical model 164 may be combined. For example, in the example of FIG. 2 the image capture devices 204 and 208 and the illumination devices 212 and 216 may be connected to a central computing device in the room 200 or elsewhere on network 116. Such central computing device may implement a combination of one or more cognitive algorithms 160 and statistical models 164 to detect contrasting regions 148 that indicate fluid spills. In some examples, image capture devices 204 and 208 and the illumination devices 212 and 216 may be communicatively coupled to an edge computing device, an internet-of-things (IoT) device, or other similar computing device that may implement one or more cognitive algorithms 160 and statistical models 164, as described above, to detect fluid spills.

In some examples, a computing device utilizing one or more statistical models 164 may be unable to definitively detect a fluid spill in a suspicious image. For example and with reference again to FIG. 2, the floor 224 in room 200 may be dirty or contaminated with extraneous material, and/or the fluid spill may be small in size. In these examples, the suspicious image may be uploaded to a cloud computing platform that may specialize in analyzing suspicious images. The cloud computing platform may implement more computationally expensive methods, such as using cognitive algorithms, which may return a more definitive result than the one generated by the local computing device. Cloud-based implementations may also have more data sets available for analysis and comparison, and may determine if a fluid is present with more resolution than the local device.

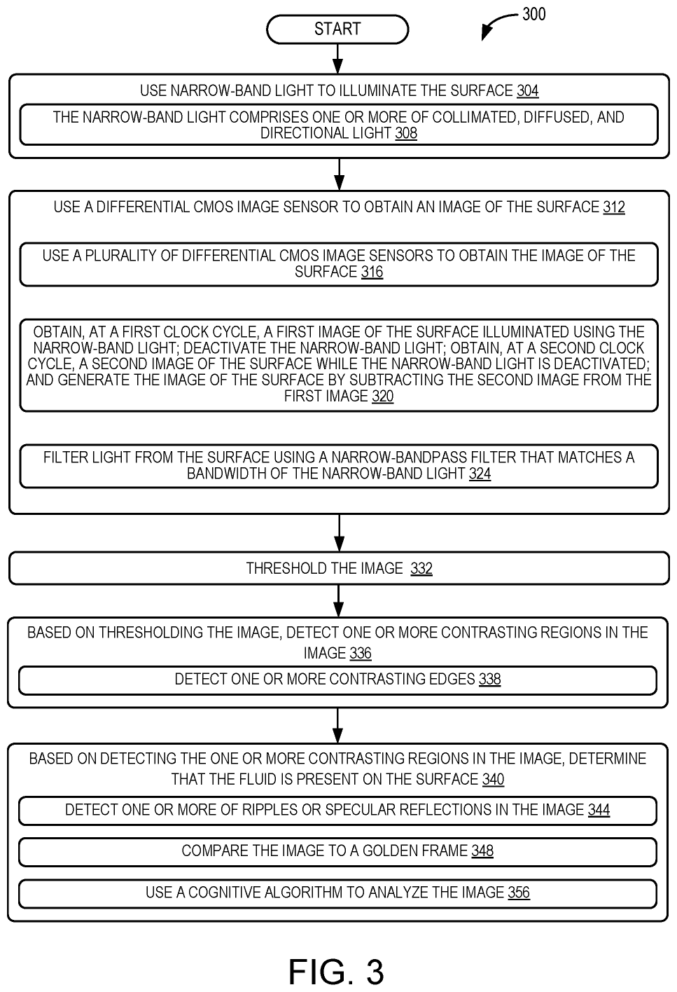

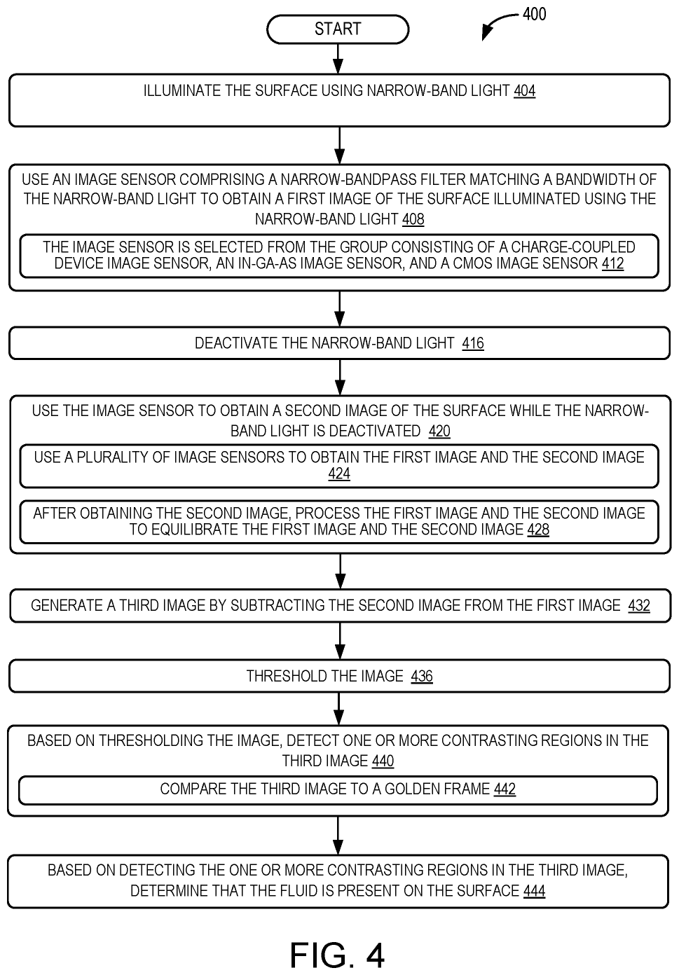

With reference now to FIGS. 3 and 4, flow charts are illustrated of example methods 300 and 400 for determining if a fluid is present on a surface. The following description of methods 300 and 400 are provided with reference to the software and hardware components described herein and shown in FIGS. 1, 2, and 5-7. It will be appreciated that method 300 and/or method 400 also may be performed in other contexts using other suitable hardware and software components.

With reference to FIG. 3, at 304, the method 300 may include using narrow-band light to illuminate a surface. At 308, the method 300 may include, wherein the narrow-band light comprises one or more of collimated, diffused, and directional light. At 312, the method 300 may include using a differential CMOS image sensor to obtain an image of the surface. At 316, the method 300 may include obtaining the image of the surface using a plurality of differential CMOS image sensors.

At 320, the method 300 may include obtaining, at a first clock cycle, a first image of the surface illuminated using the narrow-band light; deactivating the narrow-band light; obtaining, at a second clock cycle, a second image of the surface while the narrow-band light is deactivated; and generating the image of the surface by subtracting the second image from the first image. At 324, the method 300 may include, wherein obtaining the image of the surface comprises using a narrow-bandpass filter matching a bandwidth of the narrow-band light.

At 332, the method 300 may include thresholding the image. At 336, the method 300 may include, based on thresholding the image, detecting one or more contrasting regions in the image. At 338, the method 300 may include, wherein detecting one or more contrasting regions comprises detecting one or more contrasting edges in the image. At 340, the method 300 may include, based on detecting the one or more contrasting regions in the image, determining that the fluid is present on the surface.

At 344, the method 300 may include, wherein determining that the fluid is present on the surface comprises detecting one or more of ripples or specular reflections in the image. At 348, the method 300 may include wherein detecting one or more contrasting regions in the third image comprises comparing the image to a golden frame image representing the surface without the fluid present. At 356, the method 300 may include, wherein detecting one or more contrasting regions in the image comprises using a cognitive algorithm to analyze the image.

With reference now to FIG. 4, a flow chart of another example method 400 for determining if a fluid is present on a surface is illustrated. At 404, the method 400 may include illuminating the surface using narrow-band light. At 408, the method 400 may include using an image sensor comprising a narrow-bandpass filter matching a bandwidth of the narrow-band light to obtain a first image of the surface illuminated using the narrow-band light. At 412, the method 400 may include, wherein the image sensor is selected from the group consisting of a charge-coupled device image sensor, an InGaAs image sensor, and a CMOS image sensor.

At 416, the method 400 may include deactivating the narrow-band light. At 420, the method 400 may include using the image sensor to obtain a second image of the surface while the narrow-band light is deactivated. At 424, the method 400 may include, wherein obtaining the first image of the surface and obtaining the second image of the surface comprises using a plurality of image sensors to obtain the first image of the surface and the second image of the surface. At 428, the method 400 may include, after obtaining the second image, processing the first image and the second image to equilibrate the first image and the second image.

At 432, the method 400 may include generating a third image by subtracting the second image from the first image. At 436, the method 400 may include thresholding the third image. At 440, the method 400 may include, based on thresholding the third image, detecting one or more contrasting regions in the third image. At 442, the method 400 may include, wherein detecting one or more contrasting regions in the third image comprises comparing the third image to a golden frame image representing the surface without the fluid present. At 444, the method 400 may include, based on detecting the one or more contrasting regions in the third image, determining that the fluid is present on the surface.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 5 schematically shows a non-limiting embodiment of a computing system 500 that can enact one or more of the methods and processes described above. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phones), and/or other computing devices, including wearable computing devices such as smart wristwatches and head mounted display devices. In the above examples, computing device 104, illumination devices 120, 212 and 216, and image capture devices 124, 204 and 208 may comprise computing system 500 or one or more aspects of computing system 500.

Computing system 500 includes a logic processor 504, volatile memory 508, and a non-volatile storage device 512. Computing system 500 may optionally include a display subsystem 516, input subsystem 520, communication subsystem 524 and/or other components not shown in FIG. 5.

Logic processor 504 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 504 may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 504 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 512 includes one or more physical devices configured to hold instructions executable by the logic processors to implement the methods and processes described herein. When such methods and processes are implemented, the state of non-volatile storage device 512 may be transformed—e.g., to hold different data.

Non-volatile storage device 512 may include physical devices that are removable and/or built-in. Non-volatile storage device 512 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 512 may include nonvolatile, dynamic, static, read/write, read-only, sequential-access, location-addressable, file-addressable, and/or content-addressable devices. It will be appreciated that non-volatile storage device 512 is configured to hold instructions even when power is cut to the non-volatile storage device 512.

Volatile memory 508 may include physical devices that include random access memory. Volatile memory 508 is typically utilized by logic processor 504 to temporarily store information during processing of software instructions. It will be appreciated that volatile memory 508 typically does not continue to store instructions when power is cut to the volatile memory 508.

Aspects of logic processor 504, volatile memory 508, and non-volatile storage device 512 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “program” and “application” may be used to describe an aspect of computing system 500 typically implemented in software by a processor to perform a particular function using portions of volatile memory, which function involves transformative processing that specially configures the processor to perform the function. Thus, a program or application may be instantiated via logic processor 504 executing instructions held by non-volatile storage device 512, using portions of volatile memory 508. It will be understood that different programs and/or applications may be instantiated from the same application, service, code block, object, library, routine, API, function, etc. Likewise, the same program and/or application may be instantiated by different applications, services, code blocks, objects, routines, APIs, functions, etc. The terms “program” and “application” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 516 may be used to present a visual representation of data held by non-volatile storage device 512. As the herein described methods and processes change the data held by the non-volatile storage device, and thus transform the state of the non-volatile storage device, the state of display subsystem 516 may likewise be transformed to visually represent changes in the underlying data. Display subsystem 516 may include one or more display devices utilizing virtually any type of technology. Such display devices may be combined with logic processor 504, volatile memory 508, and/or non-volatile storage device 512 in a shared enclosure, or such display devices may be peripheral display devices.

When included, input subsystem 520 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 524 may be configured to communicatively couple various computing devices described herein with each other, and with other devices. Communication subsystem 524 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 500 to send and/or receive messages to and/or from other devices via a network such as the Internet.

As described above, in some examples the systems and methods described herein may utilize one or more differential CMOS image sensors. FIG. 6 shows a simplified schematic depiction of a differential CMOS image sensor 600. The differential CMOS image sensor 600 may operate in a quasi-digital demodulation mode. In this scheme, two polysilicone gates 604 and 608 may compete to collect photo-charges. The gate with a higher bias voltage may capture almost all of the photo-charges. The gates 604 and 608 may also create a strong drift field allowing fast charge collection resulting in a high photodetector modulation contrast. Lower detector gate capacitance and voltage swing also may result in a reduction of power consumption per unit area.

With reference now to FIG. 7, a simplified differential CMOS image sensor schematic 700 and corresponding timing diagram 704 are illustrated. The differential CMOS image sensor includes two in-pixel memory storage elements 708 and 712 which may store collected photo charges as minority carriers suitable for an analog double sampling capacitor (CDS). A pixel layout of the differential CMOS image sensor has centroid symmetry, which may minimize offsets and noise. Global reset 716 clears charges from gates 604 and 608, and from memory elements 708 and 712.

During integration, modulation gates 604 and 608 may be driven with complementary column clocks, and collected photo charges accumulate into in-pixel memories 708 and 712. A DLL-based clock driver system may generate uniformly-time-spaced pixel column clocks for the differential CMOS image sensor, which may avoid large peak current transients that may be generated by balanced clock trees. Each delay line element may incorporate a feed forward component crossing from an A domain to a B domain to increase delay performance.

The following paragraphs provide additional support for the claims of the subject application. One aspect provides a method for determining if a fluid is present on a surface, comprising: illuminating the surface with narrow-band light; using a differential complementary metal-oxide-semiconductor (CMOS) image sensor to obtain an image of the surface; thresholding the image; based on thresholding the image, detecting one or more contrasting regions in the image; and based on detecting the one or more contrasting regions in the image, determining that the fluid is present on the surface. The method may additionally or alternatively include obtaining, at a first clock cycle, a first image of the surface illuminated using the narrow-band light; deactivating the narrow-band light; obtaining, at a second clock cycle, a second image of the surface while the narrow-band light is deactivated; and generating the image of the surface by subtracting the second image from the first image. The method may additionally or alternatively include, wherein obtaining the image of the surface comprises filtering light from the surface using a narrow-bandpass filter that matches a bandwidth of the narrow-band light. The method may additionally or alternatively include comparing the image to a golden frame image representing the surface without the fluid present. The method may additionally or alternatively include, wherein the narrow-band light comprises one or more of collimated, diffused, or directional light. The method may additionally or alternatively include, wherein obtaining the image of the surface comprises using a plurality of differential CMOS image sensors to obtain the image of the surface. The method may additionally or alternatively include, wherein detecting one or more contrasting regions comprises detecting one or more contrasting edges in the image. The method may additionally or alternatively include, wherein detecting one or more contrasting regions comprises detecting one or more of ripples or specular reflections in the image. The method may additionally or alternatively include, wherein detecting one or more contrasting regions in the image comprises using a cognitive algorithm to analyze the image.

Another aspect provides a method for determining if a fluid is present on a surface, comprising: illuminating the surface using narrow-band light; using an image sensor comprising a narrow-bandpass filter matching a bandwidth of the narrow-band light to obtain a first image of the surface illuminated using the narrow-band light; deactivating the narrow-band light; using the image sensor to obtain a second image of the surface while the narrow-band light is deactivated; generating a third image by subtracting the second image from the first image; thresholding the third image; based on thresholding the third image, detecting one or more contrasting regions in the third image; and based on detecting the one or more contrasting regions in the third image, determining that the fluid is present on the surface. The method may additionally or alternatively include, wherein obtaining the first image of the surface and obtaining the second image of the surface comprises using a plurality of image sensors to obtain the first image of the surface and to obtain the second image of the surface. The method may additionally or alternatively include, wherein the image sensor is selected from the group consisting of a charge-coupled device image sensor, an InGaAs image sensor, and a complementary metal-oxide-semiconductor (CMOS) image sensor. The method may additionally or alternatively include, after obtaining the second image, processing the first image and the second image to equilibrate the first image and the second image. The method may additionally or alternatively include, wherein detecting one or more contrasting regions in the third image comprises comparing the third image to a golden frame image representing the surface without the fluid present. The method may additionally or alternatively include, wherein detecting one or more contrasting regions in the third image comprises detecting one or more of contrasting edges, ripples, or specular reflections in the third image.

Another aspect provides a system for determining if a fluid is present on a surface, comprising: an illumination device; an image capture device comprising a differential complementary metal-oxide-semiconductor (CMOS) image sensor; and a computing device comprising a processor and a memory holding instructions executable by the processor to, control the illumination device to illuminate the surface with narrow-band light; obtain, from the image capture device, an image of the surface illuminated using the illumination device; threshold the image; based on thresholding the image, detect one or more contrasting regions in the image; and based on detecting the one or more contrasting regions in the image, determine that the fluid is present on the surface. The system may additionally or alternatively include, wherein the illumination device is configured to illuminate the surface by emitting one or more of collimated, diffused, or directional narrow-band light. The system may additionally or alternatively include, wherein the instructions are further executable to: obtain, at a first clock cycle, a first image of the surface illuminated using the illumination device; deactivate the illumination device; obtain, at a second clock cycle, a second image of the surface while the illumination device is deactivated; and generate the image of the surface by subtracting the second image from the first image. The system may additionally or alternatively include, wherein the image capture device comprises a narrow-bandpass filter matching a bandwidth of the narrow-band light, and the image of the surface is generated by filtering light from the surface using the narrow-bandpass filter. The system may additionally or alternatively include, wherein the instructions are further executable to detect the one or more contrasting regions by comparing the image of the surface to a golden frame image representing the surface without the fluid present.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for determining if a fluid is present on a surface, comprising:
illuminating the surface with narrow-band light;
using a differential complementary metal-oxide-semiconductor (CMOS) image sensor to obtain an image of the surface;
thresholding the image;
based on thresholding the image, detecting one or more contrasting regions in the image; and
based on detecting the one or more contrasting regions in the image, determining that the fluid is present on the surface.

2. The method of claim 1, wherein obtaining the image of the surface comprises:
obtaining, at a first clock cycle, a first image of the surface illuminated using the narrow-band light;
deactivating the narrow-band light;
obtaining, at a second clock cycle, a second image of the surface while the narrow-band light is deactivated; and
generating the image of the surface by subtracting the second image from the first image.

3. The method of claim 1, wherein obtaining the image of the surface comprises filtering light from the surface using a narrow-bandpass filter that matches a bandwidth of the narrow-band light.

4. The method of claim 1, further comprising comparing the image to a golden frame image representing the surface without the fluid present.

5. The method of claim 1, wherein the narrow-band light comprises one or more of collimated, diffused, or directional light.

6. The method of claim 1, wherein obtaining the image of the surface comprises using a plurality of differential CMOS image sensors to obtain the image of the surface.

7. The method of claim 1, wherein detecting one or more contrasting regions comprises detecting one or more contrasting edges in the image.

8. The method of claim 1, wherein detecting one or more contrasting regions comprises detecting one or more of ripples or specular reflections in the image.

9. The method of claim 1, wherein detecting one or more contrasting regions in the image comprises using a cognitive algorithm to analyze the image.

10. A method for determining if a fluid is present on a surface, comprising:
illuminating the surface using narrow-band light;
using an image sensor comprising a narrow-bandpass filter matching a bandwidth of the narrow-band light to obtain a first image of the surface illuminated using the narrow-band light;
deactivating the narrow-band light;
using the image sensor to obtain a second image of the surface while the narrow-band light is deactivated;
generating a third image by subtracting the second image from the first image;
thresholding the third image;
based on thresholding the third image, detecting one or more contrasting regions in the third image; and
based on detecting the one or more contrasting regions in the third image, determining that the fluid is present on the surface.

11. The method of claim 10, wherein obtaining the first image of the surface and obtaining the second image of the surface comprises using a plurality of image sensors to obtain the first image of the surface and to obtain the second image of the surface.

12. The method of claim 10, wherein the image sensor is selected from the group consisting of a charge-coupled device image sensor, an InGaAs image sensor, and a complementary metal-oxide-semiconductor (CMOS) image sensor.

13. The method of claim 10, further comprising, after obtaining the second image, processing the first image and the second image to equilibrate the first image and the second image.

14. The method of claim 10, wherein detecting one or more contrasting regions in the third image comprises comparing the third image to a golden frame image representing the surface without the fluid present.

15. The method of claim 10, wherein detecting one or more contrasting regions in the third image comprises detecting one or more of contrasting edges, ripples, or specular reflections in the third image.

16. A system for determining if a fluid is present on a surface, comprising:
an illumination device;
an image capture device comprising a differential complementary metal-oxide-semiconductor (CMOS) image sensor; and
a computing device comprising a processor and a memory holding instructions executable by the processor to,
control the illumination device to illuminate the surface with narrow-band light;
obtain, from the image capture device, an image of the surface illuminated using the illumination device;
threshold the image;
based on thresholding the image, detect one or more contrasting regions in the image; and
based on detecting the one or more contrasting regions in the image, determine that the fluid is present on the surface.

17. The system of claim 16, wherein the illumination device is configured to illuminate the surface by emitting one or more of collimated, diffused, or directional narrow-band light.

18. The system of claim 16, wherein the instructions are further executable to:
obtain, at a first clock cycle, a first image of the surface illuminated using the illumination device;
deactivate the illumination device;
obtain, at a second clock cycle, a second image of the surface while the illumination device is deactivated; and
generate the image of the surface by subtracting the second image from the first image.

19. The system of claim 16, wherein the image capture device comprises a narrow-bandpass filter matching a bandwidth of the narrow-band light, and the image of the surface is generated by filtering light from the surface using the narrow-bandpass filter.

20. The system of claim 16, wherein the instructions are further executable to detect the one or more contrasting regions by comparing the image of the surface to a golden frame image representing the surface without the fluid present.
